(19) United States
(12) Patent Application Publication
(10) Pub. No.: US 2008/0063930 A1
(43) Pub. Date: Mar. 13, 2008

(54) Universal portable power pack

(76) Inventor: Rhett J. Karr, Springfield, OR (US)

Correspondence Address: Galasso & Associates, LP, P.O. Box 26503, Austin, TX, 78755-0503, US

(21) Appl. No.: 11/517,796

(22) Filed: Sep. 8, 2006

(51) Int. Cl. H01M 2/10; H01R 13/62

(52) U.S. Cl. 429/123; 429/187; 429/99; 439/366

(57) ABSTRACT

Universal Portable Power Pack is a plastic and impact resistant housing capable of covering a set of double A batteries. A wire running from the housing and operatively connected to the batteries leads to a typical 12 VDC socket that accepts any standard car adaptor. The device works by allowing a user to plug any electronic device that has a car adaptor into the socket to power the device.

### CROSS REFERENCE TO RELATED APPLICATIONS

This Non-Provisional patent application does not claim priority to any United States provisional patent application nor any foreign patent application.

### FIELD OF THE DISCLOSURE

The disclosures made herein relate generally to the electronics industry. The invention discussed herein is in the general classification of battery re-chargers and power sources.

### BACKGROUND

Millions of people use cell phones, personal data assistants, blackberries, portable compact disc players and other electronic devices as part of their everyday lives. Many children's toys and a variety of other accessories also utilize battery power. Unfortunately, most of these devices do not use the same type of battery packs, though many can utilize car adaptors for power. As a result, a user must purchase separate battery packs for each portable electronic device he or she owns. This solution is expensive as many of the power packs are costly. In addition, utilizing a variety of power packs is inconvenient because the user must transport all of them and constantly insert different power packs into the appropriate devices should the original power packs dissipate all of their energy.

Hence, there is a need in the art for a convenient, inexpensive and effective device for powering any device capable of utilizing a car adaptor.

### SUMMARY OF THE DISCLOSURE

Universal Portable Power Pack consists of a housing capable of covering a set of batteries. A wire emanating from the housing and operatively connected to the batteries leads to a typical 12 VDC socket that accepts any standard car adaptor. The device works by allowing a user to plug any electronic device that has a car adaptor into the socket to power the device.

The principal object of this invention is to provide a device that can power a portable electronic device.

Another object of this invention is to provide a device that can recharge its own batteries.

Another object of this invention is to provide a device that can be easily used and is effective in powering a multitude of electronic devices.

Yet another object of this invention is to provide an affordable device for powering a multitude of electronic devices.

### BRIEF DESCRIPTION OF THE DRAWINGS

FIG. 1 depicts a perspective view of the preferred embodiment of the present invention.

FIG. 2 depicts a cross-sectional view of the preferred embodiment of the invention cut along the line A-A of FIG. 1.

### DETAILED DESCRIPTION OF THE DRAWINGS

The preferred embodiment of Universal Portable Power Pack is comprised of at least some of the following: a plastic and impact resistant housing capable of covering a set of double A batteries, a wire emanating from the housing and operatively connected to the batteries and a typical 12 volt-dc current (VDC) socket that accepts any standard car adaptor. The device works by allowing a user to plug any electronic device that has a car adaptor into the socket to power the device.

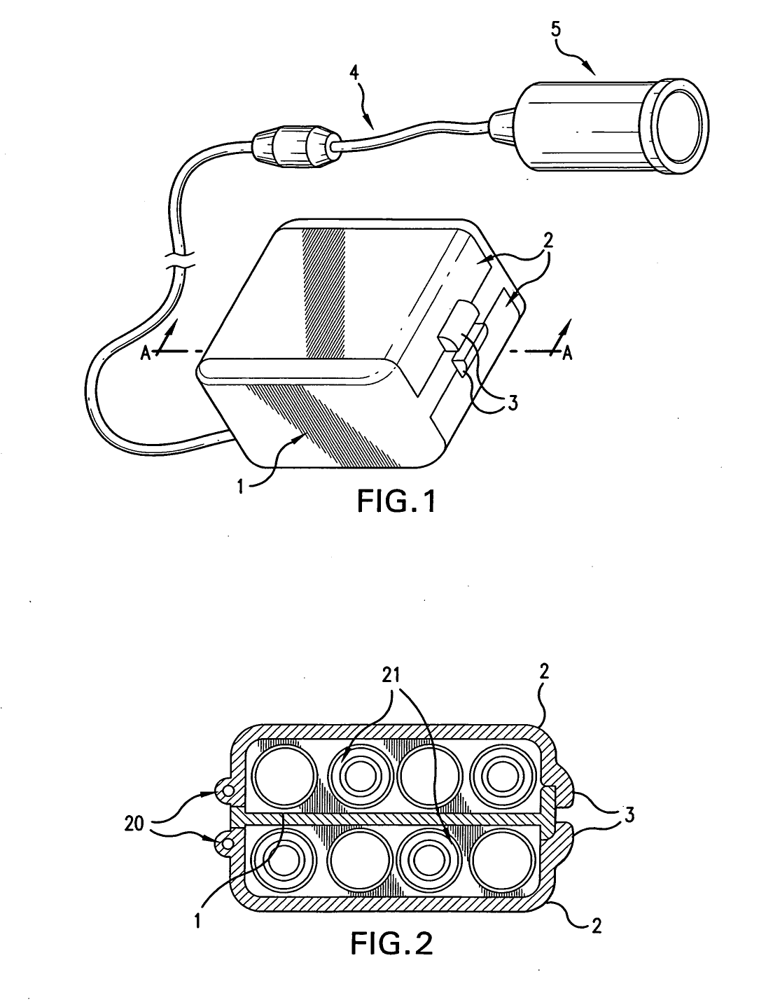

In the preferred embodiment of the invention, shown in FIG. 1, an approximately square housing 1 having two hinged covers 2 is designed to accommodate a set of eight double A batteries (four under each cover). The housing 1 is ideally made of an impact resistant plastic though a variety of materials could be utilized and be within the spirit of the invention. The two hinged covers 2 have handles 3 toward the front of the housing 1 for easy opening and insertion of batteries. When the two hinged covers 2 are open, batteries can be inserted to run parallel with the front of the housing 1. Obviously, the housing could be configured to accept the batteries in a different manner. The housing should also contain the customary electronic components and appropriate contact points to utilize the batteries.

A wire 4 operatively connected to the batteries and emerging from the housing 1 has a 12 VDC socket 5 on the end to accept any standard car adaptor. The wire 4 is insulated with plastic, rubber or some other suitable material.

FIG. 2 depicts a cross-sectional view of the preferred embodiment of the invention cut along the line A-A of FIG. 1. The hinge pins 20 that allow the two hinged covers 2 to open and close are shown at the rear of the housing 1. The batteries 21 are also shown within the housing 1. The handles 3 at the front of the housing 1 are also shown in detail.

In an alternative embodiment of the invention, the 12 VDC socket can be removed and a car adaptor or standard plug can be inserted to allow the batteries of the power pack to be recharged when it is connected to a car's cigarette lighter or standard outlet.

To use Universal Portable Power Pack, an operator simply opens the covers of the housing using the handles and inserts eight AA batteries within the housing and closes the respective covers. Then, any electronic device capable of utilizing a car adaptor can be plugged into the 12 VDC socket. The power pack can then provide power to the electronic device. When the power from the power pack is exhausted, new batteries can be inserted or the batteries can be recharged in certain embodiments of the invention.

The components of Universal Portable Power Pack may vary widely but will likely use metal, plastic, and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Universal Portable Power Pack can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of metals or other suitable materials and can be of any color. It should further be obvious that although the present invention is ordinarily used for smaller, portable electronic devices, it could be used with any electronic device having a car adaptor.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A power generating device comprising:
(a) a housing containing a contact point for operation of a battery;
(b) a wire emanating from the housing and operatively connected to the contact point; and
(c) a socket for accepting an adaptor attached to the wire.

2. The power generating device of claim 1 wherein the housing is made of plastic.

3. The power generating device of claim 1 wherein the housing is approximately square.

4. The power generating device of claim 1 wherein the housing has at least one cover with a handle on one side of the housing and a hinge pin on the other side of the housing.

5. The power generating device of claim 1 wherein the wire is covered by an insulating material.

6. The power generating device of claim 5 wherein the insulating material is rubber.

7. The power generating device of claim 5 wherein the insulating material is plastic.

8. The power generating device of claim 1 wherein the socket accommodates 12 VDC.

9. The power generating device of claim 1 wherein the socket is removable.

10. The power generating device of claim 9 wherein the socket is replaceable by a car adaptor.

11. The power generating device of claim 9 wherein the socket is replaceable by a standard plug.

12. A power generating device comprising:
(a) a housing that is approximately square and made of plastic and contains a set of eight double A batteries;
(b) a first cover on top of the housing with a first handle on the front of the housing and a first hinge pin on the rear of the housing;
(c) a second cover on bottom of the housing with a second handle on the front of the housing and a second hinge pin on the rear of the housing;
(d) a wire insulated by plastic emanating from the housing and operatively connected to the set of eight double A batteries; and
(e) a 12 VDC socket attached to the wire for accepting a car adaptor.
